(19) United States
(12) Patent Application Publication
(10) Pub. No.: US 2014/0164993 A1
(43) Pub. Date: Jun. 12, 2014

(54) METHOD AND ELECTRONIC DEVICE FOR ENLARGING AND DISPLAYING CONTENTS

(71) Applicant: Samsung Electronics Co., Ltd., Suwon-si (KR)

(72) Inventor: In-Bum CHANG, Suwon-si (KR)

(73) Assignee: Samsung Electronics Co., Ltd., Suwon-si (KR)

(21) Appl. No.: 14/103,074

(22) Filed: Dec. 11, 2013

(30) Foreign Application Priority Data
Dec. 11, 2012 (KR) 10-2012-0143737

(51) Int. Cl. G06F 3/0481

(52) U.S. Cl. CPC G06F 3/0481
USPC 715/800

(57) ABSTRACT

A method and an electronic device for enlarging and displaying contents are provided. The method includes contents that are enlarged and displayed based on a first region among a plurality of regions in which respective contents are displayed. A touch operation moving at a threshold speed or more is detected. An enlarge ratio of the contents is controlled based on a second region corresponding to a movement direction of the detected touch among abutting regions of the first region. The second region of the enlarge ratio-controlled contents is displayed.

### CROSS-REFERENCE TO RELATED APPLICATION(S)

This application claims the benefit under 35 U.S.C. §119(a) of a Korean patent application filed on Dec. 11, 2012 in the Korean Intellectual Property Office and assigned Serial No. 10-2012-0143737, the entire disclosure of which is hereby incorporated by reference.

### TECHNICAL FIELD

The present disclosure relates to an electronic device. More particularly, the present disclosure relates to a method and an apparatus for enlarging and displaying contents in an electronic device.

### BACKGROUND

With the rapid development of an electronic device such as a smartphone, a tablet Personal Computer (PC), etc., an electronic device enabling wireless voice communication and information exchange has become a daily necessity. In an early stage of distribution, the electronic device has been recognized as a portable device that merely enables wireless communication, but as a technology thereof develops and a wireless Internet is introduced, the electronic device gets out of the portable device enabling simple wireless communication and evolves into a multimedia device performing functions of schedule management, games, a remote controller, image shooting, a projector, etc., meeting a user's need.

Particularly, as convenience and portability of an electronic device become important, miniaturized electronic devices are brought to market. However, in a case of displaying contents using miniaturized electronic devices, a user has inconvenience in using contents due to a small-sized display unit. For example, in a case of displaying an image including a small character at a miniaturized smartphone, a user has inconvenience in reading characters included in an image due to a small-sized touchscreen. Accordingly, an electronic device provides a function of enlarging and displaying an image under a user control. For example, an electronic device provides a function of allowing a user to multi-touch the touchscreen of the electronic device to enlarge or reduce an image. However, this function has a disadvantage that a user has to repeatedly perform a fine touch in order to enlarge and view a desired region.

Therefore, there is a need for a method for enlarging and controlling contents more intuitively in an electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for enlarging and displaying contents in an electronic device.

Another aspect of the present disclosure is to provide a method and an apparatus for enlarging and displaying contents divided into a plurality of regions in an electronic device.

Still another aspect of the present disclosure is to provide a method and an apparatus for enlarging and displaying a region corresponding to a touch direction when detecting a touch of contents divided into a plurality of regions in an electronic device.

Yet another aspect of the present disclosure is to provide a method and an apparatus for determining a region to enlarge and display among a plurality of regions with consideration of only a touch direction regardless of a position and a movement distance where a touch has been detected in the case where the touch is detected with contents divided into the plurality of regions enlarged in an electronic device.

In accordance with an aspect of the present disclosure, a method for enlarging and displaying contents in an electronic device is provided. The method includes enlarging and displaying contents based on a first region among a plurality of regions in which respective contents are displayed, detecting a touch operation moving at a threshold speed or more, controlling an enlarge ratio of the contents based on a second region corresponding to a movement direction of the touch among abutting regions of the first region, and displaying the second region of the enlarge ratio-controlled contents.

In accordance with another aspect of the present disclosure, an apparatus for enlarging and displaying contents is provided. The apparatus includes one or more processors, a touchscreen, a memory, and one or more programs stored in the memory and configured for execution by the one or more processors, wherein the one or more programs includes an instruction for enlarging and displaying contents based on a first region among a plurality of regions in which respective contents are displayed, an instruction for detecting a touch operation moving at a threshold speed or more, an instruction for controlling an enlarge ratio of the contents based on a second region corresponding to a movement direction of the touch among abutting regions of the first region, and an instruction for displaying the second region of the enlarge ratio-controlled contents.

In accordance with yet another aspect of the present disclosure, a method in an electronic device is provided. The method includes displaying contents in a first region among a plurality of regions, detecting a touch movement that is equal to or greater than a threshold speed, controlling an enlarge ratio of the contents based on a second region disposed in a movement direction of the detected touch, and displaying the second region of the enlarge ratio-controlled contents.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a block diagram illustrating an electronic device according to an embodiment of the present disclosure;

FIG. 1B is a block diagram illustrating a processor according to an embodiment of the present disclosure;

FIG. 2A is a flowchart illustrating a procedure for controlling to enlarge and display contents in an electronic device according to an embodiment of the present disclosure;

FIG. 2B is a view illustrating means for controlling to enlarge and display contents in an electronic device according to an embodiment of the present disclosure;

FIG. 3 is a flowchart illustrating a detailed procedure for controlling to enlarge and display contents in an electronic device according to an embodiment of the present disclosure;

FIG. 4A is a view illustrating an example of a screen displaying contents divided into a plurality of regions in an electronic device according to an embodiment of the present disclosure;

FIG. 4B is a view illustrating an example of a screen enlarging and displaying contents divided into a plurality of regions based on a specific region in an electronic device according to an embodiment of the present disclosure; and

FIGS. 5A, 5B, 6A, 6B, 7A, and 7B are views illustrating examples of detecting a touch direction and displaying an abutting region of a currently displayed region in enlarged and displayed contents in an electronic device according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions are omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure are provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the description below, an electronic device denotes all electronic devices having a touchscreen. For example, the electronic device may be a mobile communication terminal, a smartphone, a tablet Personal Computer (PC), a digital audio player, a navigation device, and a TeleVision (TV).

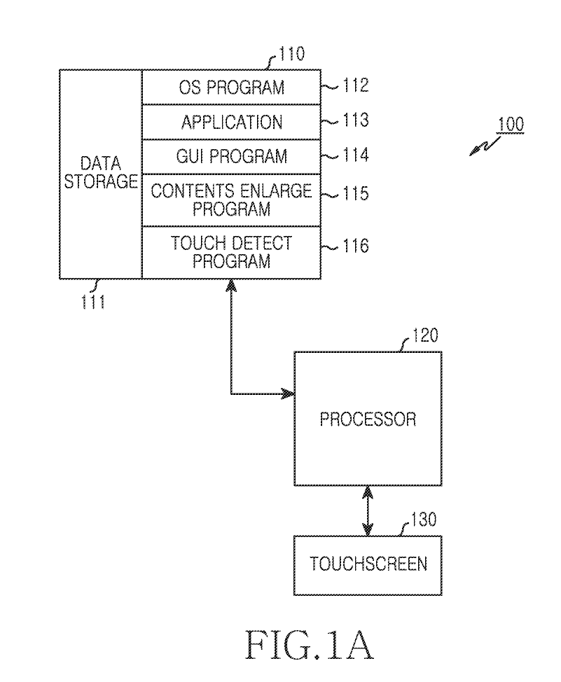

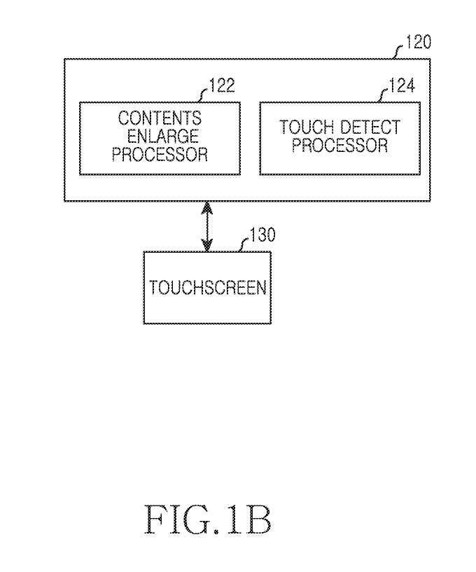

FIG. 1A is a block diagram illustrating an electronic device according to an embodiment of the present disclosure.

Referring to FIG. 1A, the electronic device 100 includes a memory 110, a processor 120, and a touchscreen 130. A plurality of memories 110 and processors 120 may exist.

The memory 110 includes a data storage 111, an Operating System (OS) program 112, an application 113, a Graphic User Interface (GUI) program 114, a contents enlarge program 115, and a touch detect program 116. Also, since a program which is a software element may be expressed as a set of instructions, the program may be expressed as an instruction set. The program may be also expressed as a module.

The memory 110 may store one or more programs including instructions for performing an embodiment of the present disclosure.

The data storage 111 stores data generated during execution of a function corresponding to a program stored in the memory 110 in an electronic device. The data storage 111 according to the present disclosure stores various contents divided into a plurality of regions. Here, the contents may be a web page, an electronic document, an image, text, and a moving picture that may be divided into a plurality of regions. Also, the data storage 111 may store information regarding a method for dividing contents that are not divided into a plurality of regions into a plurality of regions.

The OS program 112 (for example, WINDOWS, LINUX, Darwin, RTXC, UNIX, OS X, or a built-in OS such as VxWorks) includes various software elements for controlling the general system operation. For example, the control of the general system operation denotes memory management and control, storage hardware (device) control and management, power control and management, etc. The OS program 112 performs a function for swift communication between various hardware (devices) and software elements (programs).

The application 113 includes an application such as a browser application, an email application, a messaging application, a word processing application, an address book application, a widget application, a Digital Right Management (DRM) application, a voice recognition application, a voice duplication application, a position determining function application, a location based service application, a telephone application, etc.

The GUI program 114 includes at least one software element for providing a user interface using graphics between a user and the electronic device 100. That is, the GUI program 114 includes at least one software element for displaying user interface information on the touchscreen 130. According to the present disclosure, the GUI program 114 includes an instruction for displaying contents on the touchscreen 130. For example, the GUI program 114 includes an instruction for displaying image contents on the touchscreen 130. For another example, the GUI program 114 includes an instruction for displaying a web page on the touchscreen 130.

In addition, the GUI program 114 includes an instruction for enlarging and displaying contents currently being displayed on the touchscreen according to a request of a contents enlarge program 115. At this point, the GUI program 114 includes an instruction for enlarging and displaying contents based on a specific region where a touch has been detected among a plurality of regions of the contents according to a request of the contents enlarge program 115. The enlarging and displaying of the contents based on the specific region denotes enlarging the contents with consideration of the width and/or the height of the touchscreen 130 and the width and/or the height of a specific region, and then displaying such that the specific region of the enlarged contents is positioned on a predetermined position (e.g., the center of the screen) of the touchscreen 130. This function may be referred to as a block zoom. Here, the block denotes each region of contents.

Also, with a portion of contents including a first region among the enlarged entire region of the contents displayed, the GUI program 114 may enlarge and display another region abutting on the first region on the center of the screen instead of the first region currently displayed on the center of the screen according to a request of the contents enlarge program 115.

When occurrence of a contents enlarge event is detected by the touch detect program 116 while contents divided into a plurality of regions are displayed, the contents enlarge program 115 controls and processes a function for enlarging and displaying the contents based on a specific region where a touch has been detected according to an embodiment of the present disclosure.

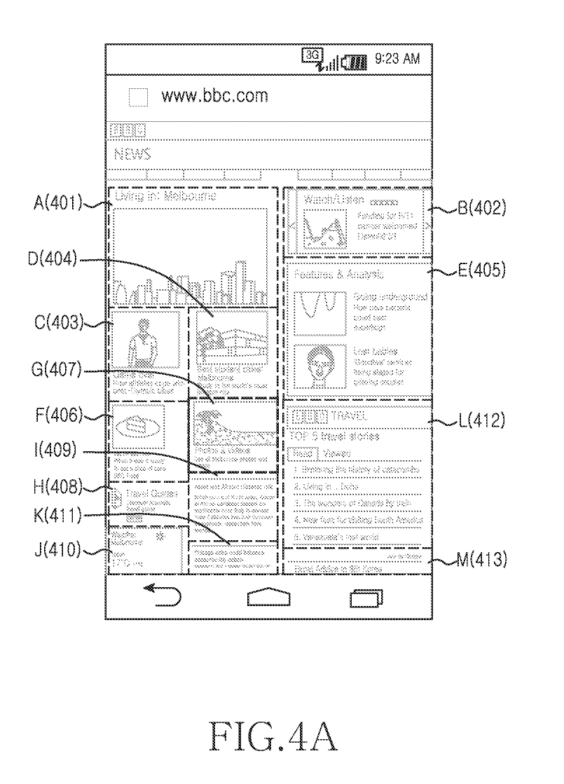

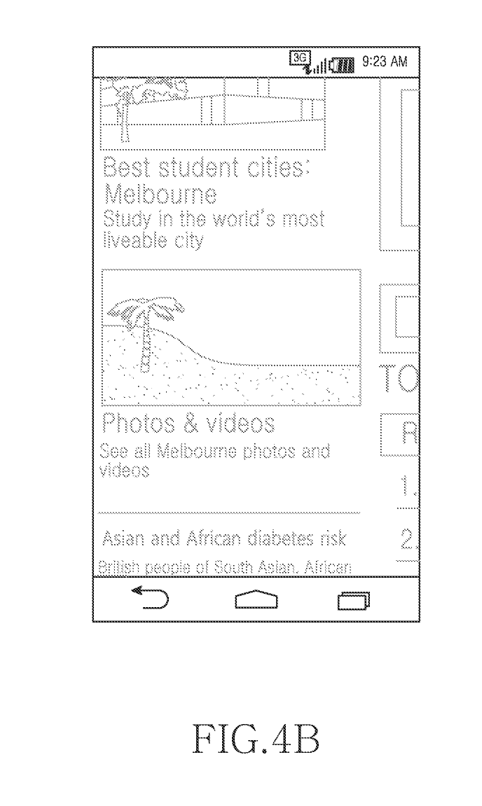

FIG. 4A is a view illustrating an example of a screen displaying contents divided into a plurality of regions in an electronic device according to an embodiment of the present disclosure. FIG. 4B is a view illustrating an example of a screen enlarging and displaying contents divided into a plurality of regions based on a specific region in an electronic device according to an embodiment of the present disclosure.

For example, when a double tap for a region G 407 is detected while a web page divided into regions A to M (401 to 413) is displayed as illustrated in FIG. 4A, the contents enlarge program 115 controls and processes a function for enlarging and displaying the web page such that the region G 407 is positioned on the center of the screen as illustrated in FIG. 4B. At this point, an enlarge ratio of the contents may be determined depending on the width and/or the height of the touchscreen 130 and the width and/or the height of the specific region where a touch has been detected. For example, the contents enlarge program 115 may determine an enlarge ratio such that the width of the specific region is the same as the width of the touchscreen 130 to enlarge the contents, and may determine an enlarge ratio such that the width of the specific region is smaller than the width of the touchscreen 130 by a threshold to enlarge the contents. Regions abutting on the specific region of the contents may or may not be displayed on the screen depending on this contents enlarge ratio. For example, the contents enlarge program 115 may enlarge a web page such that the width of the region G 407 is displayed smaller than the width of the touchscreen 130 by the threshold as illustrated in FIG. 4B. In this case, a portion or the whole of at least one region among regions C 403, D 404, E 405, F 406, H 408, I 409, and L 412 abutting the region G 407 may be displayed on the touchscreen 130. Here, the contents enlarge program 115 may divide contents into a plurality of regions and store information related to the divided region in the data storage 111 according to a predetermined scheme.

Also, according to an embodiment of the present disclosure, the contents enlarge program 115 controls and processes a function for detecting occurrence of a flick event for contents using the touch detect program 116, receiving direction information of the flick event from the touch detect program 116, and then selecting a region corresponding to the direction of the flick event among abutting regions of a specific region currently enlarged and displayed on the touchscreen 130, and enlarging and displaying contents based on the selected region. At this point, the contents enlarge program 115 selects an abutting region to be displayed with consideration of only the direction of the flick event regardless of the start position, the end position, and the length of the flick event, and controls an enlarge ratio of the contents with consideration of the width and/or the height of the selected abutting region. Here, the flick denotes a touch where speeds of several touch points right before a touch ends are greater than a threshold speed. Also, the contents enlarge program 115 may analyze a position relationship of a plurality of regions in which respective contents are displayed, and select an abutting region corresponding to the direction of the flick event among regions abutting on the specific region based on the analyzed position relationship.

Hereafter, an example is described below on the assumption that a web page divided into regions A to M 401 to 412 is enlarged and displayed based on the region G 407 as illustrated in FIGS. 4A and 4B.

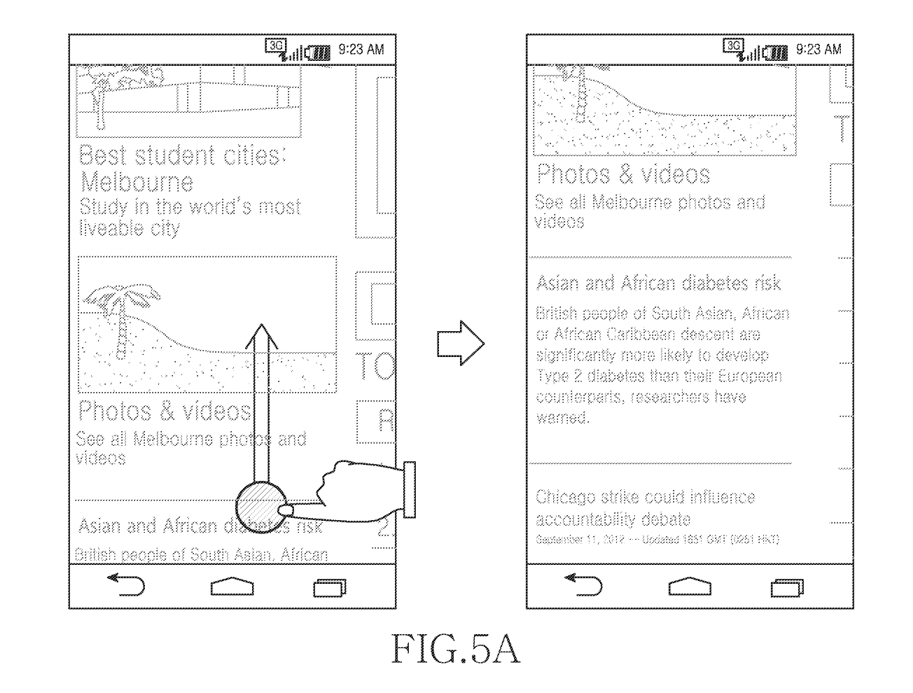

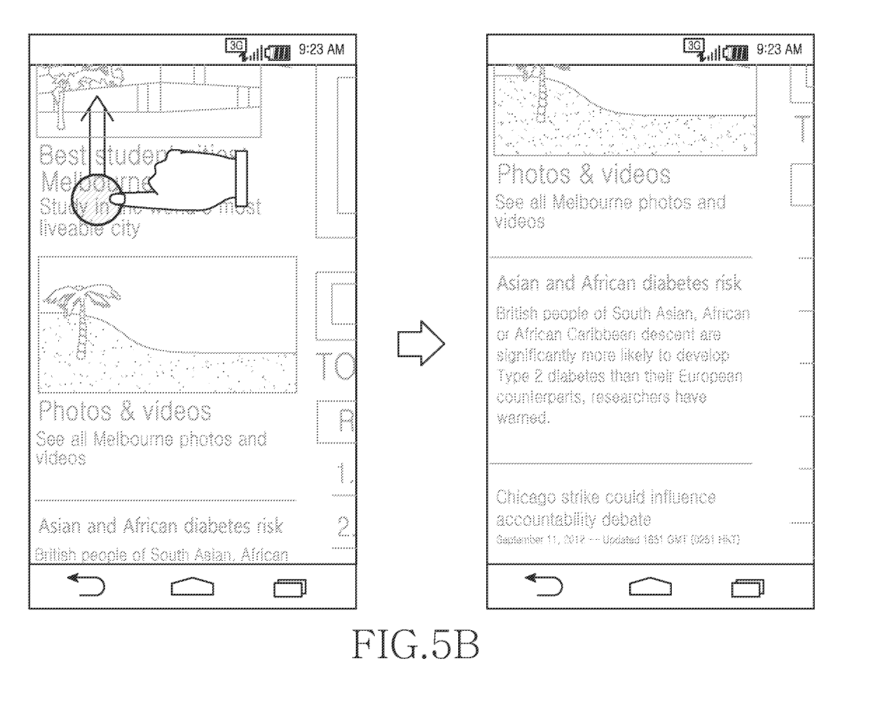

FIGS. 5A, 5B, 6A, 6B, 7A, and 7B are views illustrating examples of detecting a touch direction and displaying an abutting region of a currently displayed region in enlarged and displayed contents in an electronic device according to an embodiment of the present disclosure.

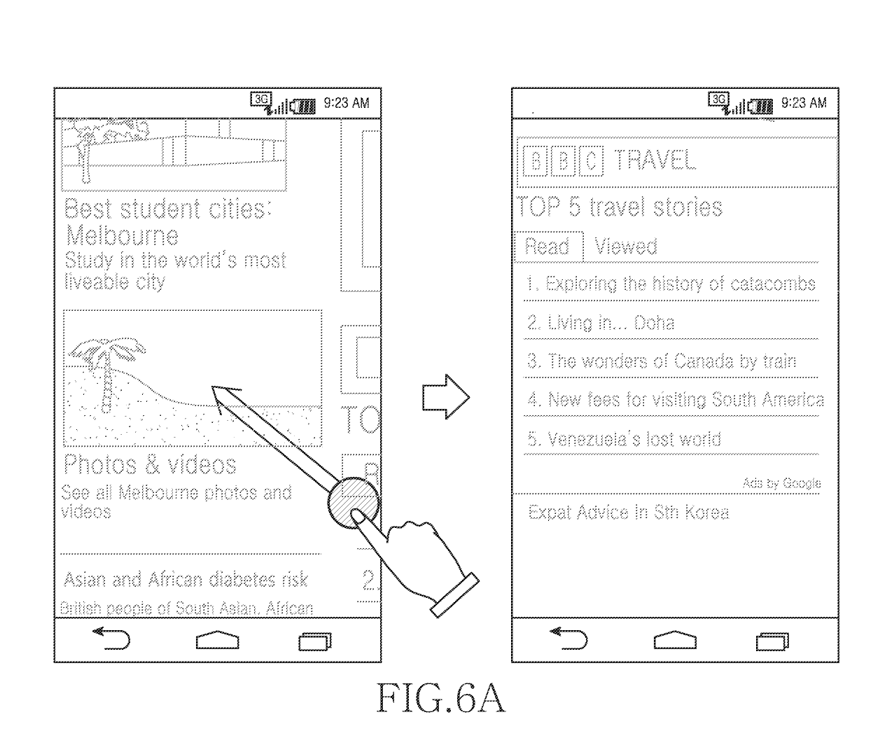

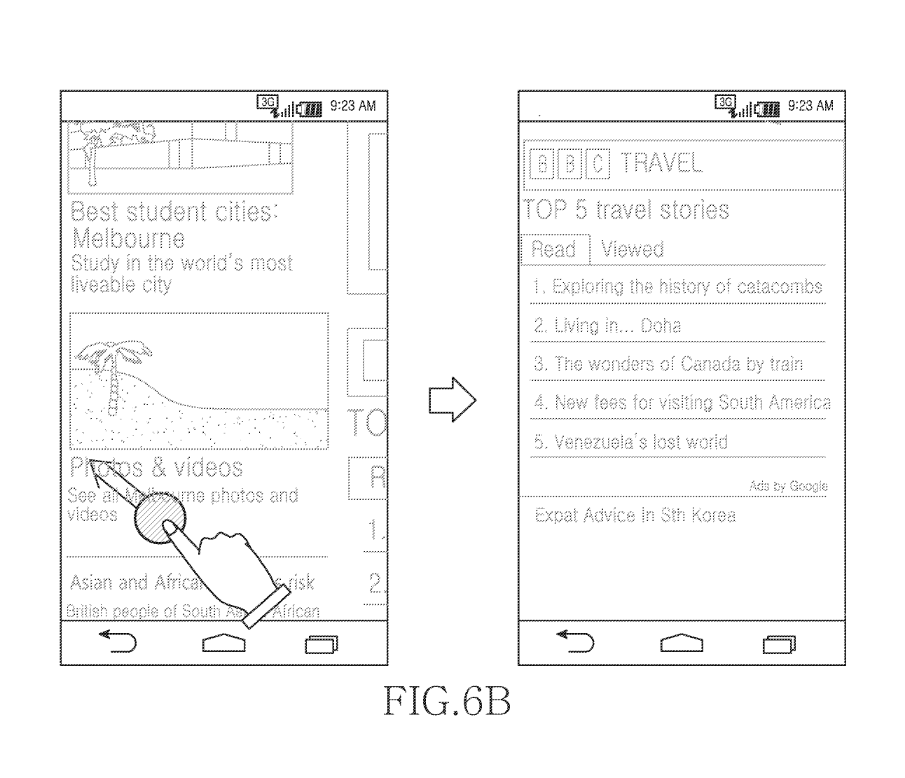

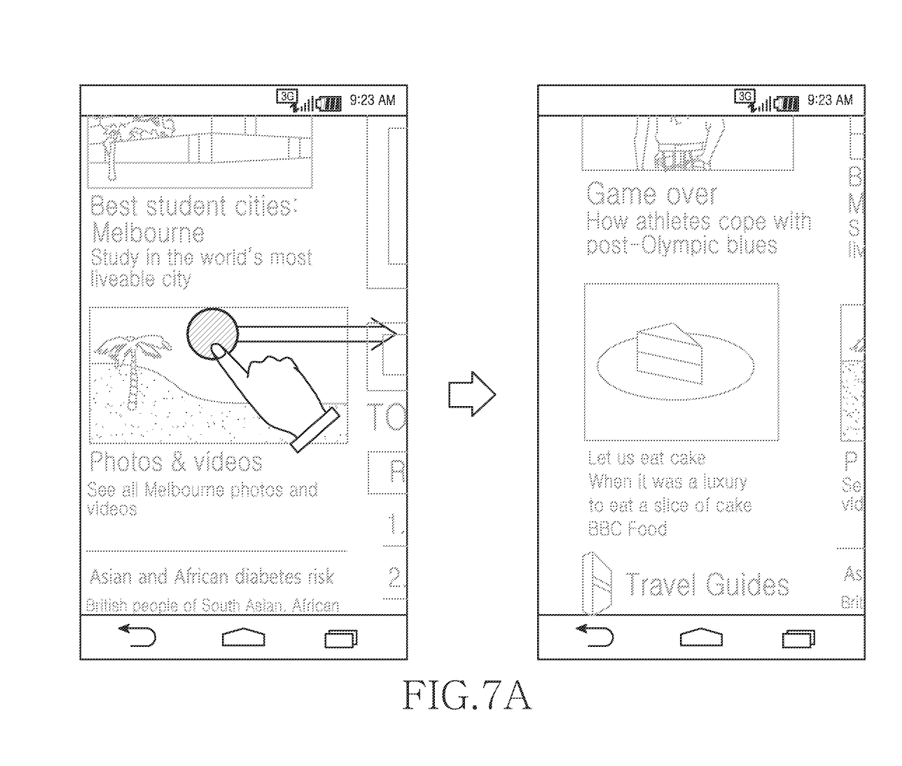

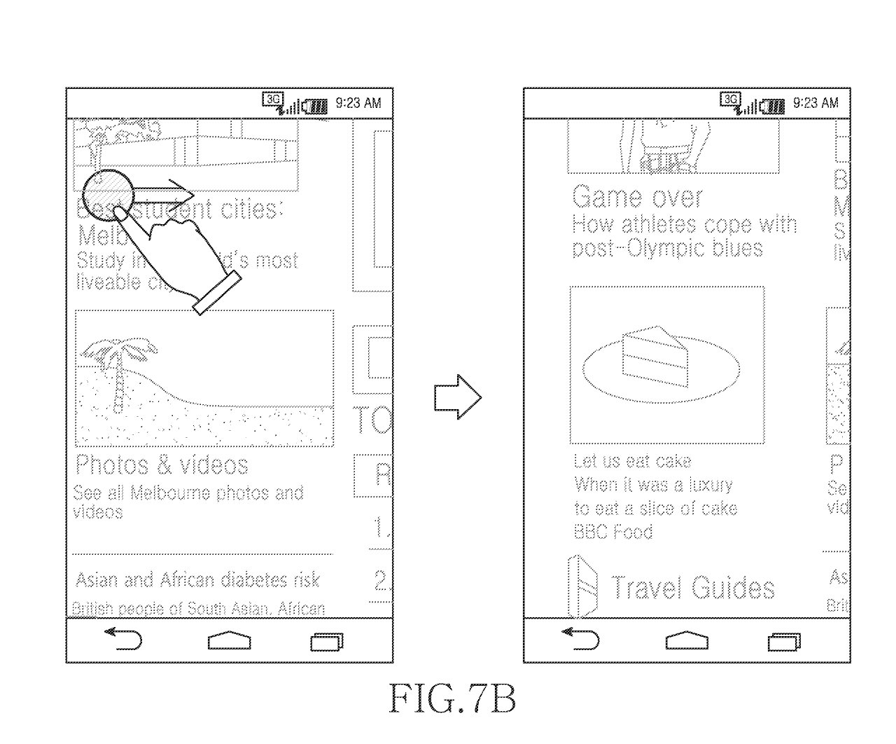

At this point, in the case where a flick progressing from the bottom to the top in the lower region of the touchscreen 130 is detected as illustrated in FIG. 5A, or a flick progressing from the bottom to the top in the upper region of the touchscreen 130 is detected as illustrated in FIG. 5B, the contents enlarge program 115 includes an instruction for determining an enlarge ratio such that the width of a region I 409 positioned under the region G 407 is smaller than the width of the touchscreen 130 by the threshold, re-enlarging or reducing the contents at the determined ratio, and then displaying the region I 409 in the re-enlarged or reduced contents on the touchscreen 130. For another example, in the case where a flick progressing from the direction of 4:00 to the direction of 10:00 at the right lower region of the touchscreen 130 is detected as illustrated in FIG. 6A, or a flick progressing from the direction of 5:00 to the direction of 11:00 in the left lower region of the touchscreen 130 is detected as illustrated in FIG. 6B, the contents enlarge program 115 includes an instruction for determining an enlarge ratio such that the width of a region L 412 positioned in the direction of 4:00 or 5:00 based on the region G 407 is smaller than the width of the touchscreen 130 by the threshold, re-enlarging or reducing the contents at the determined ratio, and then displaying the region L 412 in the re-enlarged or reduced contents on the touchscreen 130. For still another example, in the case where a flick progressing from the left to the right in the central region of the touchscreen 130 is detected as illustrated in FIG. 7A or a flick progressing from the left to the right in the left upper region of the touchscreen 130 is detected as illustrated in FIG. 7B, the contents enlarge program 115 includes an instruction for determining an enlarge ratio such that the width of a region F 406 positioned in the left of the region G 407 is smaller than the width of the touchscreen 130 by the threshold, re-enlarging or reducing the contents at the determined ratio, and then displaying the region F 406 in the re-enlarged or reduced contents on the touchscreen 130. That is, the contents enlarge program 115 according to an embodiment of the present disclosure selects an abutting region to be displayed with consideration of only a direction regardless of the start portion, the end position, and the length of a flick event, and re-enlarges or reduces contents based on the selected abutting region to display the same. According to an embodiment of the present disclosure, in the case where the width of a currently displayed region is the same as the width of a selected abutting region, the contents enlarge program 115 may omit the process for determining an enlarge ratio based on the width of an abutting region to re-enlarge or reduce contents. Of course, the above description is made on the assumption that a reference of determining an enlarge ratio is a width. That is, in the case where the reference of determining an enlarge ratio is the height of a region, when the height of a current displayed region is the same as the height of a selected abutting region, the contents enlarge program 115 may omit a process for determining an enlarge ratio based on the height of an abutting region and re-enlarging or reducing contents.

The touch detect program 116 may detect various touch gestures for the touchscreen 130. For example, the touch detect program 116 may detect a double tap for enlarging contents, and detect a flick for moving and displaying a region with contents enlarged based on a specific region.

Though not shown, the processor 120 may include at least one processor and a neighbor interface. Also, the processor 120 executes a specific program (e.g., instruction set) stored in the memory 110 to perform a plurality of specific functions corresponding to the program.

The touchscreen 130 has a touch-sensitive display for providing an interface for a touch input/output between the electronic device 100 and a user. The touchscreen 130 is a medium for detecting a touch (or contact) for the touchscreen 130 via a touch sensor (not shown), transferring a detected touch input to the electronic device 100, and providing an output from the electronic device 100 to a user visually. That is, the touchscreen 130 provides a visual output that is based on text, graphics, and video to a user in response to a touch input.

The touchscreen 130 includes a touch detect plane for detecting a user's touch input to detect a user's touch input by a haptic contact, a tactile contact, or a combination of these. For example, a touch detect point of the touchscreen 130 corresponds to a digit of a finger used for a contact for the touch detect plane. Also, the touchscreen 130 detects a contact by an external device such as a stylus pen, etc. via the touch detect plane. The detected contact is converted to an interaction corresponding to a user interface object (for example, a soft key) displayed on the touchscreen.

FIG. 1B is a block diagram illustrating a processor according to an embodiment of the present disclosure.

Referring to FIG. 1B, the processor 120 according to the present disclosure includes a contents enlarge processor 122 and a touch detect processor 124.

The processor 120 controls and processes an overall operation of the electronic device, and controls and processes a function for enlarging and displaying contents divided into a plurality of regions via the contents enlarge processor 122 and the touch detect processor 124 depending on a selected region.

When occurrence of a contents enlarge event is detected by the touch detect processor 124 while contents divided into a plurality of regions are displayed, the contents enlarge processor 122 controls and processes a function for enlarging and displaying the contents based on a specific region where a touch has been detected according to an embodiment of the present disclosure. At this point, a content enlarge ratio may be determined depending on the width and/or the height of the touchscreen 130, and the width and/or the height of the specific region where the touch has been detected.

Also, according to an embodiment of the present disclosure, the contents enlarge processor 122 controls and processes a function for detecting occurrence of a flick event for contents using the touch detect processor 124, receiving direction information of the flick event from the touch detect processor 124, and then selecting a region corresponding to the direction of the flick event among abutting regions of a specific region currently enlarged and displayed on the touchscreen 130, and enlarging and displaying contents based on the selected region. At this point, the contents enlarge processor 122 selects an abutting region to be displayed with consideration of only a direction regardless of the start position, the end position, and the length of the flick event, and controls an enlarge ratio of the contents with consideration of the width and/or the height of the selected abutting region. Here, the flick denotes a touch where speeds of several touch points right before a touch ends are greater than a threshold speed. Also, the contents enlarge program 115 may analyze a position relationship of a plurality of regions in which respective contents are displayed, and select an abutting region corresponding to the direction of the flick event among regions abutting on a specific region based on the analyzed position relationship.

The touch detect processor 124 may detect various gestures for the touchscreen 130. For example, the touch detect processor 124 may detect a double tap for enlarging contents, and detect a flick for moving and displaying a region with contents enlarged based on a specific region.

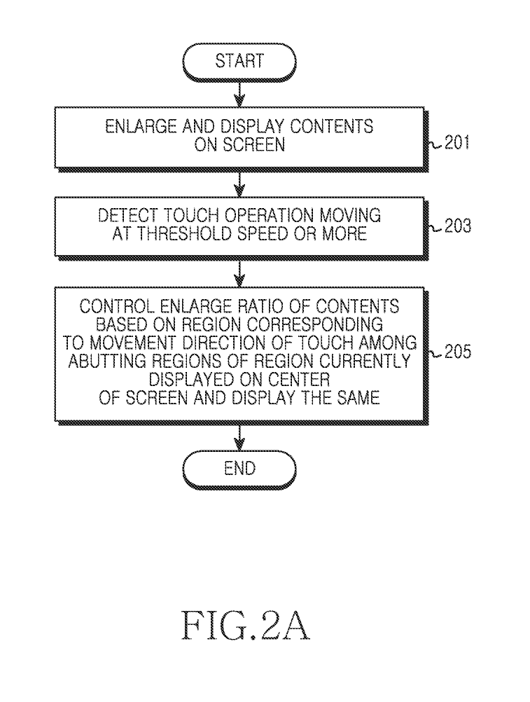

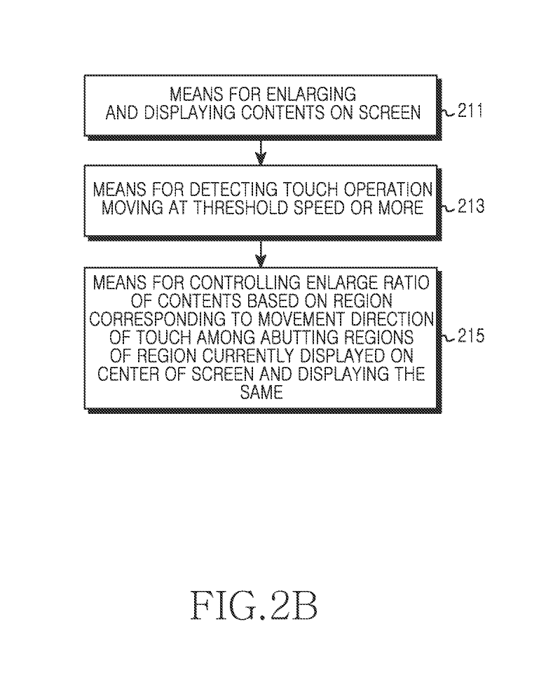

FIG. 2A illustrates a procedure for controlling to enlarge and display contents in an electronic device according to an embodiment of the present disclosure.

Referring to FIG. 2A, the electronic device enlarges and displays contents based on a first region among a plurality of regions forming the contents in operation 201. For example, the electronic device enlarges a web page based on a first region where a user gesture has been detected among a plurality of regions forming the web page when displaying the web page, and displays the web page such that the first region of the enlarged web page is positioned on a predetermined region of the screen.

After that, the electronic device detects a touch operation moving at a threshold speed or more in operation 203. For example, the electronic device detects a flick event for the enlarged and displayed contents.

After that, the electronic device controls an enlarge ratio of contents based on a second region corresponding to a movement direction of a touch among abutting regions of the first region currently displayed on the screen, and displays the enlarge ratio-controlled contents in operation 205. For example, the electronic device selects the second region corresponding to the direction of a flick event among a plurality of regions abutting on the first region, and then determines an enlarge ratio of a web page based on the selected second region, re-enlarges or reduces the web page depending on the determined enlarge ratio, and then displays the web page such that the second region of the re-enlarged or reduced web page is positioned on a predetermined region of the screen.

FIG. 2B illustrates means for controlling to enlarge and display contents in an electronic device according to an embodiment of the present disclosure.

Referring to FIG. 2B, the electronic device includes means 211 for enlarging and displaying contents based on a first region among a plurality of regions forming the contents, and means 213 for detecting a touch operation moving at a threshold speed or more. For example, the electronic device includes means for enlarging a web page based on the first region where a user gesture has been detected among the plurality of regions forming the web page and displaying the web page such that the first region of the enlarged web page is positioned on a predetermined region of the screen, and means for detecting a flick event for the enlarged and displayed contents.

The electronic device includes means for controlling an enlarge ratio of the contents based on the second region corresponding to the movement direction of a touch among abutting regions of the first region currently displayed on the screen, and displaying the enlarge ratio-controlled contents. For example, the electronic device includes means for selecting the second region corresponding to the direction of a flick event among the plurality of regions abutting on the first region, and then determining an enlarge ratio of a web page based on the selected second region, re-enlarging or reducing the web page depending on the determined enlarge ratio, and then displaying the web page such that the second region of the re-enlarged or reduced web page is positioned on a predetermined region of the screen.

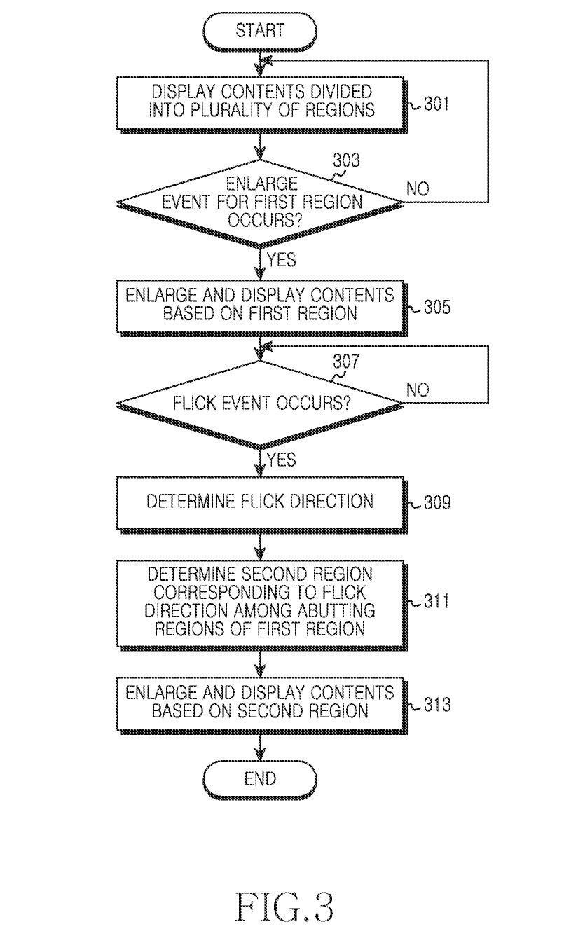

FIG. 3 illustrates a detailed procedure for controlling to enlarge and display contents in an electronic device according to an embodiment of the present disclosure.

Referring to FIG. 3, the electronic device displays contents divided into a plurality of regions in operation 301. For example, the electronic device displays a web page where various information such as news, shopping information, weather information, social network information, advertisement information, etc. are divided into different regions and provided.

After that, the electronic device determines whether an enlarge event for the first region occurs among a plurality of regions forming the contents in operation 303. For example, the electronic device may determine whether a double tap for the first region is detected, and when the double tap is detected, the electronic device may determine an enlarge event has occurred. When an enlarge event for the first region does not occur, the electronic device returns to operation 301 to perform subsequent steps.

In contrast, when an enlarge event for the first region occurs, the electronic device proceeds to operation 305 to enlarge and display the contents based on the first region. At this point, an enlarge ratio of the contents may be determined depending on the width and/or the height of the touchscreen 130 and the width and/or the height of the first region. For example, as illustrated in FIG. 4A, when a double tap for a region G 407 is detected while a web page divided into regions A to M (401 to 412) is being displayed, the electronic device may determine an enlarge ratio such that the width of the region G 407 is smaller than the width of the touchscreen 130 by a threshold, enlarge the web page according to the determined enlarge ratio, and enlarge and display the region G 407 on the center of the screen as illustrated in FIG. 4B.

After that, the electronic device proceeds to operation 307 to determine whether a flick event occurs. Here, the flick denotes a touch where speeds of several touch points right before a touch ends are greater than a threshold speed.

When a flick event occurs, the electronic device determines the direction of the flick, that is, the direction of a touch that progresses at a threshold speed or more in operation 309, proceeds to operation 311 to determine a second region corresponding to the direction of the flick among abutting regions of the first region. The electronic device may analyze a position relationship of the plurality of regions forming the contents, and determine the second region corresponding to the direction of the flick among regions abutting on the first region based on the analyzed position relationship. Also, the electronic device determines the second region with consideration of only the direction of the flick regardless of the start position, the end position, and the length of the flick. After that, the electronic device proceeds to operation 313 to re-enlarge or reduce the contents based on the second region, and then display the re-enlarged or reduced contents such that the second region is positioned on a predetermined region of the screen. For example, in the case where a flick progressing from the bottom to the top in the lower region of the touchscreen 130 is detected as illustrated in FIG. 5A, or a flick progressing from the bottom to the top in the upper region of the touchscreen 130 is detected as illustrated in FIG. 5B, the electronic device determines a region I 409 positioned at the lower end among regions abutting on the region G 407, determines an enlarge ratio such that the width of the region I 409 is smaller than the width of the touchscreen 130 by the threshold, and then re-enlarges or reduces the web page at the determined enlarge ratio, and displays the web page such that the region I 409 is positioned at a predetermined position of the touchscreen 130 in the re-enlarged or reduced web page.

After that, the electronic device ends the procedure according to the embodiment of the present disclosure.

As described above, when a flick event is detected while the contents are enlarged and displayed based on a specific region of the contents, the present disclosure may enlarge and display an abutting region of a currently displayed region without requiring a user's repeated performance of a fine touch in order to view a desired region by enlarging and displaying the contents such that an abutting region corresponding to the direction of the flick event among regions abutting on the currently displayed specific region is positioned at the center of the screen. For example, a description is made on the assumption that a user intends to view a region L 412 abutting on a region G 407 while a web page is enlarged and displayed based on the region G 407 of the web page as illustrated in FIG. 6A. According to the related-art, a user has to touch the region L 412 positioned at the right lower end to perform a long drag from the direction of 4:00 to the direction of 11:00, and then perform an operation of tediously moving up/down/left/right again to display the region L 412 on the center of the screen. However, according to a method proposed by the present disclosure, a user may display the region L 412 on the center of the screen by performing only a flick operation to the direction corresponding to the position of the region L 412.

The embodiments and all functional operations of the present disclosure described in the present specification may be implemented by a computer software, a firmware, or a hardware, or one or more combinations of these including the structure and equivalent structures thereof disclosed in the present specification. Also, the embodiments of the disclosure described in the present specification may be executed by one or more computer program products, that is, data processing devices, or one or more modules of computer program instructions encoded on a non-transitory computer-readable medium for controlling the operation of this device.

The non-transitory computer-readable medium may be a machine-readable storage medium, a machine-readable storage substrate, a memory unit, composition of a material influencing a machine-readable radio wave stream, or a combination of one or more of these. A terminology of a data processing device includes a programmable processor, a computer, or all apparatuses, devices, and machines for data processing including a multi processor or a computer, for example. The apparatuses may include a code added to a hardware and generating an execution environment for a relevant computer program, for example, a code forming a processor firmware, a protocol stack, a database management system, an operating system, or a combination of one or more of these.

According to the present disclosure, an electronic device enlarges and displays contents divided into a plurality of regions, and then when detecting a touch for the enlarged contents, the electronic device determines a display region with consideration of only the direction of the touch regardless of the position and the movement distance where the touch has been detected, moves the enlarged contents to the center of the determined display region, and then enlarges and displays the same, so that a user may enlarge and display an abutting region of the currently displayed region with only one time of a touch operation without repeatedly performing a fine touch in order to view a desired region.

The embodiments of the present disclosure may be realized in the form of a hardware, a software, or a combination of a hardware and a software. The software may be stored in a volatile storage medium or a non-volatile storage medium.

The storage medium may be a storage unit such as a Read Only Memory (ROM), a memory unit such as a Random Access Memory (RAM), a memory chip or an integrated circuit, an optical or magnetic recording medium such as a Compact Disc (CD), a Digital Versatile Disc (DVD), a magnetic disc, or a magnetic tape. The storage unit or the storage medium is a non-transitory machine language-readable storage means suitable for storing a program including instructions realizing the present disclosure. Therefore, the embodiments provide a program including codes realizing an apparatus or a method described in claims of the present disclosure. Also, these programs may be distributed via a wired or wireless communication network, and stored and executed via a distribution method.

A terminology of “include (comprise)” described in the content of the specification and claims, and a terminology of “including (comprising)” which is modification thereof have meaning of “include but not limited” and do not exclude other additional compositions, components, or processes, etc.

A singular form descried in the content of the specification and claims includes a plural form unless specifically described in particular. Particularly, in the case an indefinite article is used, it is understood that it includes the singular and the plural.

A shape, a number, a characteristic, a group, etc. described in relation to the specific embodiment of the present disclosure are usable also in other embodiments unless they are incompatible.

A terminology expressed by “X for Y” (Y means a behavior or a process, and X represents means for performing such a behavior or process) throughout the content of the specification and claims includes X specifically arranged or applied for performing Y, but not limited thereto.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in an electronic device, the method comprising:
enlarging and displaying contents based on a first region among a plurality of regions in which respective contents are displayed;
detecting a touch operation moving at a threshold speed or more;
controlling an enlarge ratio of the contents based on a second region corresponding to a movement direction of the detected touch among abutting regions of the first region; and
displaying the second region of the enlarge ratio-controlled contents.

2. The method of claim 1, further comprising:
selecting the second region among the abutting regions of the first region with consideration of only the movement direction of the touch regardless of a start position where the touch is detected, an end position, and a length of the touch.

3. The method of claim 2, wherein the selecting of the second region comprises:
selecting an abutting region of a position corresponding to the movement direction of the touch as the second region with consideration of a position relationship of the first region and the regions abutting on the first region.

4. The method of claim 1, wherein the controlling of the enlarge ratio of the contents based on the second region corresponding to the movement direction of the touch among the abutting regions of the first region comprises:
determining the enlarge ratio of the contents based on at least one of a width and a height of the second region, and at least one of a width and a height of a display provided to the electronic device; and
re-enlarging or reducing the contents enlarged based on the first region depending on the determined enlarge ratio.

5. The method of claim 4, wherein the determining of the enlarge ratio comprises:
determining the enlarge ratio such that the at least one of the width and the height of the second region is the same as the at least one of the width and the height of the display provided to the electronic device.

6. The method of claim 4, wherein the determining of the enlarge ratio comprises:
determining the enlarge ratio such that the at least one of the width and the height of the second region is smaller than the at least one of the width and the height of the display provided to the electronic device by a threshold.

7. The method of claim 1, wherein the displaying of the second region of the enlarge ratio-controlled contents comprises:
displaying the contents such that the second region of the enlarge ratio-controlled contents is displayed on a predetermined region of a display provided to the electronic device.

8. An electronic device comprising:
one or more processors;
a touchscreen;
a memory; and
one or more programs stored in the memory and configured for execution by the one or more processors,
wherein the one or more programs comprises an instruction for enlarging and displaying contents based on a first region among a plurality of regions in which respective contents are displayed, an instruction for detecting a touch operation moving at a threshold speed or more, an instruction for controlling an enlarge ratio of the contents based on a second region corresponding to a movement direction of the touch among abutting regions of the first region, and an instruction for displaying the second region of the enlarge ratio-controlled contents.

9. The electronic device of claim 8, wherein the one or more programs further comprises an instruction for selecting the second region among the abutting regions of the first region with consideration of only the movement direction of the touch regardless of a start position where the touch is detected, an end position, and a length of the touch.

10. The electronic device of claim 9, wherein the one or more programs further comprises an instruction for selecting an abutting region of a position corresponding to the movement direction of the touch as the second region with consideration of a position relationship of the first region and the regions abutting on the first region.

11. The electronic device of claim 8, wherein the one or more programs further comprises an instruction for determining the enlarge ratio of the contents based on at least one of a width and a height of the second region, and at least one of a width and a height of a display provided to the electronic device, and an instruction for re-enlarging or reducing the contents enlarged based on the first region depending on the determined enlarge ratio.

12. The electronic device of claim 11, wherein the one or more programs further comprises an instruction for determining the enlarge ratio such that the at least one of the width and the height of the second region is the same as the at least one of the width and the height of the display provided to the electronic device.

13. The electronic device of claim 11, wherein the one or more programs further comprises an instruction for determining the enlarge ratio such that the at least one of the width and the height of the second region is smaller than the at least one of the width and the height of the display provided to the electronic device by a threshold.

14. The electronic device of claim 11, wherein the one or more programs further comprises an instruction for displaying the contents such that the second region of the enlarged ratio-controlled contents is displayed on a predetermined region of a display provided to the electronic device.

15. A method in an electronic device, the method comprising:
displaying contents in a first region among a plurality of regions;
detecting a touch movement that is equal to or greater than a threshold speed;
controlling an enlarge ratio of the contents based on a second region disposed in a movement direction of the detected touch; and
displaying the second region of the enlarge ratio-controlled contents.
